(19) United States
(12) Patent Application Publication
(10) Pub. No.: US 2009/0064960 A1
(43) Pub. Date: Mar. 12, 2009

(54) ONE-PART SEAL MATERIAL COMPOSITION CURABLE AT AMBIENT TEMPERATURE, AND INTAKE MANIFOLD USING THE SAME

(75) Inventors: Masahiro MASUJIMA, Wako-shi (JP); Kazutaka YOKOYAMA, Wako-shi (JP); Shingo TSUNO, Tokyo (JP); Kiyotaka SAWA, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: HONDA MOTOR CO., LTD., Tokyo (JP); Henkel Japan Ltd., Tokyo (JP)

(21) Appl. No.: 12/207,208

(22) Filed: Sep. 9, 2008

(30) Foreign Application Priority Data
Sep. 11, 2007 (JP) 2007-236012

(51) Int. Cl. F02M 35/104; C08L 33/00

(52) U.S. Cl. 123/184.61; 524/556

(57) ABSTRACT

A one-part seal material composition curable at ambient temperature is provided that can meet all the requirements of: adhesiveness to weight saving materials; strength which can endure use in automotive parts; viscosity appropriate for enhancing efficiency of mass production; and fuel vapor sealing properties, and an intake manifold using the same. In a one-part seal material composition curable at ambient temperature which is hardened by a atmospheric moisture, (A) a polyacrylate having the end blocked with a hydrolyzable silyl group; and (B) a plasticizer are included, in which the content of the component (B) is set to be 15 parts by mass to 35 parts by mass per 100 parts by mass of the component (A). Furthermore, an intake manifold is produced using the composition.

This application is based on and claims the benefit of priority from Japanese Patent Application No. 2007-236012, filed on 11 Sep. 2007, the content of which is incorporated herein by reference.

### BACKGROUND OF THE INVENTION

1. Field of the Invention

The present invention relates to a one-part seal material composition curable at ambient temperature, and an intake manifold using the same.

2. Related Art

Conventionally, materials referred to as gaskets have been used for the purpose of preventing leakage of liquid or gas occurring at joints of the members. In particular, liquid gaskets are applied on the mating surfaces of the members in the state of liquid, and turned into a cohesive material piece with time, thereby preventing liquids and/or gases from leakage. The material of the liquid gasket includes a seal material composition constituted with silicone, polyacrylate or the like.

The liquid gaskets as described above constituted with a seal material composition have been suitably used in adhesion and sealing of automotive members. For example, Japanese Unexamined Patent Application, First Publication No. 2003-226862 (Patent Document 1) discloses a silicone based seal composition having favorable adhesiveness to metals such as aluminum, magnesium and the like. In addition, Japanese Unexamined Patent Application, First Publication No. 2005-281617 (Patent Document 2) discloses a liquid gasket constituted with an acrylic resin.

In addition, Japanese Unexamined Patent Application, First Publication No. 2005-320519 (Patent Document 3) and Japanese Unexamined Patent Application, First Publication No. 2006-131650 (Patent Document 4) disclose a curable composition including a vinyl based polymer as an essential component, and being applicable as liquid gaskets for automobiles. According to Japanese Unexamined Patent Application, First Publication No. 2005-320519 and Japanese Unexamined Patent Application, First Publication No. 2006-131650, a curable composition having superior weather resistance, adhesiveness, and strength is reportedly obtained.

### SUMMARY OF THE INVENTION

Among the automotive members, the liquid gasket compositions which can be suitably used for intake manifolds in internal combustion engines require the following four performance criteria. More specifically, (i) adhesiveness to weight saving materials, (ii) strength which can endure use as automotive parts, (iii) viscosity appropriate for enhancing the efficiency of mass production, and (iv) sealing properties for fuel vapors are demanded.

Particularly, in light of weight savings, magnesium or a magnesium alloy is often used in automobiles, whereby strong adhesiveness is required also to these magnesium based materials. In addition, the fuel vapor flows into the intake manifold since EGR (exhaust gas recirculation) in which a part of the exhaust gas is drawn from the exhaust system and recirculated to the intake system again has been employed in gasoline engines and diesel engines. Also, when the engine is stopped, particularly superior fuel vapor sealing properties are required such that the fuel vapor does not leak outside since the fuel vapor is recirculated from the injector port, and the uncombusted gas is also recirculated.

Recently, in light of environmental problems, inhibiting permeation of the fuel has been desired for all automotive parts. Particularly, in terms of achievement of control of PZEV (Partial-Credit Zero Emission Vehicle) and the like in the USA, there exists a strong need for seal material compositions having superior fuel vapor sealing properties while EGR is utilized, and having an appropriate viscosity, which can impart sufficient strength and adhesiveness.

However, the seal material composition disclosed in Patent Document 1 is still disadvantageous in the fuel vapor sealing properties. In addition, the seal material compositions disclosed in Patent Documents 2 to 4 cannot provide adhesiveness to weight saving materials, and the shear strength that enables use as an automotive part, although superior fuel vapor sealing properties can be achieved.

An object of the present invention is to provide a one-part seal material composition curable at ambient temperature, which meets the requirements of: adhesiveness to weight saving materials; strength which can endure use as automotive parts; viscosity appropriate for enhancing efficiency of mass production; and sealing properties for fuel vapors, and an intake manifold using the same.

The present inventors have conducted extensive research in order to solve the problems described above, taking into consideration the amount of the blended plasticizer. As a consequence, it was found that the aforementioned problems can be solved by blending a polyacrylate having the end blocked with a silyl group, with a plasticizer at a specified blending ratio. Accordingly, the present invention was accomplished. More specifically, the present invention provides the following.

In a first aspect, a one-part seal material composition curable at ambient temperature, which is hardened by moisture in the atmosphere, includes: (A) a polyacrylate having the end blocked with a hydrolyzable silyl group; and (B) a plasticizer, the content of component (B) being in the range of 15 to 35 parts by mass per 100 parts by mass of component (A).

According to a second aspect, in the one-part seal material composition curable at ambient temperature according to the first aspect, the component (B) has a weight average molecular weight in the range of 300 to 800.

According to a third aspect, in the one-part seal material composition curable at ambient temperature according to the first or second aspect, the end of the component (A) has an alkoxysilyl group.

According to a fourth aspect, in the one-part seal material composition curable at ambient temperature according to any one of the first to third aspects further includes: (C) an inorganic filler; and (D) a crosslinking agent.

According to the invention of any one of the first to fourth aspects, a one-part seal material composition curable at ambient temperature having appropriate viscosity can be obtained by making the amount of the used plasticizer fall within the above range. Thus, application onto the joint is facilitated, whereby the production efficiency is enhanced. In addition, high shear strength, strong adhesiveness, and superior gas sealing properties can be achieved after curing. Therefore, the one-part seal material composition curable at ambient temperature of the present invention can be used in joining a variety of members. Particularly, strong adhesiveness to weight saving materials, such as magnesium based materials and the like is exhibited, and fuel vapor sealing properties are also favorable. Therefore, it can be suitably used for joining intake manifold members for automobiles.

In a fifth aspect, an intake manifold is formed by joining multiple members, in which the one-part seal material composition curable at ambient temperature according to any one of the first to fourth aspects is used for joining the multiple members.

In a sixth aspect, an intake manifold, which has a manifold main body, and is formed by joining a metal upper member and a metal lower member, in which the one-part seal material composition curable at ambient temperature according to any one of the first to fourth aspects is used for joining the metal upper member and the metal lower member.

In a seventh aspect, the intake manifold according to the sixth aspect in which the material of the metal upper member and the metal lower member is one of magnesium and a magnesium alloy.

According to an eighth aspect, in the intake manifold according to the sixth aspect, the material of the metal upper member and the metal lower member is one of aluminum and an aluminum alloy.

According to a ninth aspect, in the intake manifold according to any one of the sixth to eighth aspects, the one-part seal material composition curable at ambient temperature applied onto the joint part of the upper member and the lower member has a width after curing of no less than 3 mm.

According to the invention of any one of the fifth to ninth aspects, an intake manifold having high performance is obtained by employing the one-part seal material composition curable at ambient temperature according to any one of the first to fourth aspects at the joints of the intake manifold, since sufficient strength, adhesiveness, and gas sealing properties are achieved. In addition, since it can also be applied to weight saving materials such as magnesium, aluminum and the like, an intake manifold having high performance and light weight can be obtained.

Particularly, according to a ninth aspect of the invention, an intake manifold having superior gas sealing properties is obtained by allowing the seal material composition applied onto the mating part of the upper member and the lower member to have a width after curing of no less than 3 mm. In addition, since it enables exhibition of more favorable effects with a small width of application as compared with products of the prior art, weight savings of the intake manifold can be further promoted, and an intake manifold having high performance can be obtained at a low cost.

According to the present invention, a one-part seal material composition curable at ambient temperature can concurrently meet all the requirements of: adhesiveness to weight saving materials, strength which can endure use in automotive parts, viscosity appropriate for enhancing efficiency of mass production, and fuel vapor sealing properties. In addition, an intake manifold having high performance can be provided by applying this seal material composition onto a mating part of the intake manifold.

### DETAILED DESCRIPTION OF THE INVENTION

Hereinafter, embodiments of the one-part seal material composition curable at ambient temperature of the present invention and the intake manifold using the same are described in detail; however, the present invention is not in any way limited to the following embodiments, and can be accomplished with appropriate alteration and modification, within the scope of the object of the present invention. Although descriptions may be arbitrarily omitted for overlapping parts, the principles of the invention are not limited thereto.

### One-Part Seal Material Composition Curable at Ambient Temperature

The one-part seal material composition curable at ambient temperature of the present invention is not particularly limited as long as: it includes (A) a polyacrylate having the end blocked with a hydrolyzable silyl group, and a plasticizer; and the plasticizer is included in an amount in the range of 15 to 30 parts by mass per 100 parts by mass of the component (A), but a filler, and a crosslinking agent are preferably included as other components.

### Polyacrylate

The polyacrylate is not particularly limited as long as it has the end blocked with a hydrolyzable silyl group.

The polyacrylate herein indicates a polymer predominantly constituted with an acrylic or methacrylic polymerizable monomer having a carbon-carbon double bond. In addition to the acrylic or methacrylic polymerizable monomer, other monomers may be also copolymerized. Examples of the other monomers include styrene based monomers, silicon-containing vinyl based monomers, fluorine-containing vinyl based monomers, nitrile group-containing vinyl based monomers, and the like. In addition, the copolymerization may be either block copolymerization or random copolymerization.

Typical examples of the polymerizable monomer include various carboxyl group-containing monomers such as acrylic acid, methacrylic acid, crotonic acid, itaconic acid, fumaric acid, maleic acid and citraconic acid, and salts thereof, various hydroxyl group-containing monomers such as 2-hydroxyethyl(meth)acrylate, 2-hydroxypropyl(meth)acrylate, 4-hydroxybutyl(meth)acrylate, monobutyl hydroxyfumarate and monobutyl hydroxyitaconate, various (meth)acrylic esters such as methyl(meth)acrylate, ethyl(meth)acrylate, propyl (meth)acrylate, butyl(meth)acrylate and lauryl (meth)acrylate, various nitrogen-containing vinyl based monomers such as (meth)acrylamide, diacetoneacrylamide, N-methylolacrylamide and (meth)acrylonitrile, various styrene derivatives such as styrene, α-methylstyrene, divinylbenzene, and vinyltoluene, various vinyl esters such as vinyl acetate and vinyl propionate, various silicon-containing polymerizable monomers such as γ-methacryloxypropyltrimethoxysilane, vinyltrimethoxysilane and “SILAPLANE FM-07” manufactured by Chisso Corporation (methacryloyl silicon macromer), phosphorus-containing vinyl based monomers, various halogenated vinyls such as vinyl chloride, vinylidene chloride, vinyl fluoride, vinylidene fluoride, trifluorochloroethylene, tetrafluoroethylene, chlorotrifluoroethylene and hexafluoropropylene, various conjugated dienes such as butadiene, and the like. Copolymers prepared using multiple kinds of the monomers are also acceptable. In this case, either random copolymerization or block copolymerization may be carried out.

As the hydrolyzable silyl group positioned at the end of the component (A), a conventionally known one can be used. Examples of the hydrolyzable group include a hydrogen atom, a halogen atom, an alkoxy group, an acyloxy group, a ketoxymate group, an amino group, an amide group, an aminooxy group, a mercapto group, and the like. Among these, an alkoxy group is particularly preferred since the alkoxysilyl group is highly reactive, whereby the curing is likely to be promoted. Specific examples of the alkoxysilyl group include a trimethoxysilyl group, a dimethoxymethylsilyl group, a dimethylmethoxysilyl group, a triethoxysilyl group, a diethoxymethylsilyl group, a dimethylethoxysilyl group, and the like.

Although the viscosity of component (A) is not particularly limited, the viscosity at 25° C. is preferably in the range of 200 to 2,000 Pa·s. A viscosity of no less than 200 Pa·s is preferred since the seal material composition after curing exhibits good physical properties such as adequate spreading and the like, while a viscosity of no greater than 2,000 Pa·s is preferred since efficient progress of the operation is enabled. More preferably, the viscosity is in the range of 400 Pa·s to 1,600 Pa·s.

The method for producing component (A) is not particularly limited, and for example, a method that includes: preparing a polyacrylate having a halogen at the end of the main chain; then preparing polyacrylate having an alkenyl group at the end of the main chain; and allowing the same to react with a silane compound in the presence of a Pt catalyst, and the like may be employed. More specifically, component (A) can be produced by the method disclosed in Japanese Unexamined Patent Application Publication No. Hei 11-080249; Japanese Unexamined Patent Application, First Publication No. Hei 11-080250; Japanese Unexamined Patent Application, First Publication No. Hei 11-005815; Japanese Unexamined Patent Application, First Publication No. Hei 11-116617; Japanese Unexamined Patent Application, First Publication No. Hei 11-116606; Japanese Unexamined Patent Application, First Publication No. Hei 11-080571; Japanese Unexamined Patent Application, First Publication No. Hei 11-080570; Japanese Unexamined Patent Application, First Publication No. Hei 11-130931; Japanese Unexamined Patent Application, First Publication No. Hei 11-100433; Japanese Unexamined Patent Application, First Publication No. Hei 11-116763; Japanese Unexamined Patent Application, First Publication No. Hei 09-272714; Japanese Unexamined Patent Application, First Publication No. Hei 09-272715, or the like.

### Plasticizer

As the plasticizer to be included in the one-part seal material composition curable at ambient temperature of the present invention, a conventionally known one can be used. Use of the plasticizer in combination with the filler described later is more advantageous since elasticity of the cured product can be increased, and a large amount of the filler can be mixed. However, the filler does not have to be necessarily added. Depending on the purpose, such as adjustment of the physical properties and regulation of the characters and the like, for example, phthalic acid esters such as dibutyl phthalate, diheptyl phthalate, di(2-ethylhexyl) phthalate, diisodecyl phthalate, and butylbenzyl phthalate; nonaromatic dibasic acid esters such as dioctyl adipate, dioctyl sebacate, dibutyl sebacate, and isodecyl succinate; aliphatic esters such as butyl oleate, and methyl acetylricinoleate; esters of polyalkylene glycol such as diethylene glycol dibenzoate, triethylene glycol dibenzoate, and pentaerythritol esters; phosphoric esters such as tricresyl phosphate, and tributyl phosphate; trimellitic acid esters; polystyrenes such as polystyrene and poly-α-methylstyrene; polybutadiene, polybutene, polyisobutylene, butadiene-acrylonitrile, and polychloroprene; chlorinated paraffins; hydrocarbon based oil such as alkyl diphenyl, and partially hydrogenated terphenyl; process oils; polyether polyols such as polyethylene glycol, polypropylene glycol, ethylene oxide-propylene oxide copolymers and polytetramethylene glycol, and polyethers of an alkyl derivative prepared by converting one end, both ends or all ends at the hydroxyl group of these polyether polyols into an alkyl ester group, an alkyl ether group or the like; epoxy group-containing plasticizers such as epoxy soybean oil, benzyl epoxystearate, and E-PS; polyester based plasticizers obtained from a dibasic acid such as sebacic acid, adipic acid, azelaic acid or phthalic acid, and a dihydric alcohol such as ethylene glycol, diethylene glycol, triethylene glycol, propylene glycol or dipropylene glycol; vinyl based polymers obtained by polymerizing a vinyl based monomer such as an acrylic plasticizer by a variety of methods, high molecular plasticizers, and the like may be included. In particular, phthalic acid esters are preferred as the plasticizer used in the present invention among these, since they are readily available. Taking into consideration the influences on the environment, it is more preferred that a nonphthalic acid ester be used. In addition, the plasticizer utilized may be a preferable one selected appropriately depending on the type of component (A) used for the effect. For example, when a polyacrylate having the end blocked with an alkoxysilyl group is used, the plasticizer is preferably diisodecyl phthalate. A low molecular plasticizer and a high molecular plasticizer can be used in combination.

The amount of the plasticizer used is in the range of 15 parts by mass to 35 parts by mass per 100 parts by mass of the component (A). More preferably, the amount is in the range of 20 parts by mass to 30 parts by mass. An amount of no less than 15 parts by mass is preferred since the one-part seal material composition curable at ambient temperature will have an appropriate viscosity, whereby working efficiency is improved, while an amount of no greater than 35 parts by mass is preferred since the one-part seal material composition curable at ambient temperature will have sufficient strength after curing.

Although a preferable amount of the plasticizer used may be appropriately altered in connection with the amount of the component (A) used for the effect, it is preferred in general that the amount falls within the above range. In the present invention, a polyacrylate having an alkoxysilyl group at the end is preferred, and the plasticizer is preferably a phthalic acid ester. The amount of the plasticizer used in this case is preferably in the range of 20 parts by mass to 30 parts by mass per 100 parts by mass of component (A).

Although the weight average molecular weight of the plasticizer is not particularly limited, it is preferably in the range of 300 to 800. The weight average molecular weight is more preferably in the range of 400 to 700. The weight average molecular weight of the plasticizer being no lower than 300 is preferred since separation of the plasticizer from component (A) can be prohibited, and thus initial physical properties can be maintained for a long period of time. In addition, the weight average molecular weight of the plasticizer being no higher than 800 is preferred since work can be carried out efficiently with an appropriate viscosity.

Although the viscosity of the plasticizer is not particularly limited, the viscosity is preferably in the range of 50 mPa·s to 300 mPa·s. The viscosity is more preferably in the range of 100 mPa·s to 200 mPa·s. A viscosity of no less than 50 mPa·s is preferred since the operation can be carried out efficiently, and a viscosity of no higher than 200 mPa·s is preferred since deterioration of the working environment resulting from volatilization of the plasticizer can be prevented.

### Crosslinking Agent

The one-part seal material composition curable at ambient temperature of the present invention preferably includes a crosslinking agent. Although the type of the crosslinking agent is not particularly limited, for example, a crosslinking agent represented by the following general formula (1) can be preferably used:

### Formula 1

R¹₄₋ₙSiSₙ (1)

Where R¹ represents a nonsubstited or monovalent hydrocarbon group; X represents a hydrolyzable group; and n is an integer of 3 or 4.

In the general formula (1), when R¹ is a monovalent hydrocarbon group, examples of the group include alkyl groups having 1 to 6 carbon atoms such as a methyl group, an ethyl group and a vinyl group, alkenyl groups, aryl groups such as a phenyl group and/or aralkyl groups. For example, phenyltrimethoxysilane, and phenyltriethoxysilane may be exemplified. Illustrative examples of the hydrolyzable group X include alkoxy groups such as a methoxy group, an ethoxy group, and a propoxy group, alkenyloxy groups such as an isopropenoxy group, and a 1-ethyl-2-methylvinyloxime group, ketoxime groups such as a dimethylketoxime group, and a methylethylketoxime group, acyloxy groups such as an acetoxy group, a propionoxy group, a butyryloxy group, and a benzoyloxime group, amino groups such as a dimethylamino group, and a diethylamino group, aminoxy groups such as a dimethylaminoxy group, and a diethylaminoxy group, amide groups such as an N-methylacetamide group, an N-ethylacetamide group, and an N-methylbenzamide group, and the like.

As specific examples of the crosslinking agent, ethyl silicate, propyl silicate, methyltrimethoxysilane, methylethoxysilane, vinyltrimethoxysilane, vinyltriethoxysilane, methyltris(methoxyethoxy)silane, vinyltris(methoxyethoxy)silane, methyltripropenoxysilane, methyltriacetoxysilane, vinyltriacetoxysilane, vinyltrimethylethylketoximesilane, methyltrimethylethylketoximesilane, methyltri(butanoxime)silane, vinyltri(butanoxime)silane, phenyltri(butanoxime)silane, propyltri(butanoxime)silane, tetra(butanoxime)silane, 3,3,3-trifluoropropyl(butanoxime)silane, 3-chloropropyl(butanoxime)silane, methyltri(propanoxime)silane, methyltri(pentanoxime)silane, methyltri(isopentanoxime)silane, vinyl(cyclopentanoxime)silane, methyltri(cyclohexanoxime)silane and the like, and partially hydrolyzed products of the same may be exemplified. In particular, vinyltrimethoxysilane and methyltrimethoxysilane are preferably used, and vinyltrimethoxysilane is more preferably used among these. The amount of the blended crosslinking agent is preferably in the range of 0.1 parts by mass to 10 parts by mass, and more preferably in the range of 1 part by mass to 5 parts by mass per 100 parts by mass of component (A). When the amount is no less than 0.1 parts by mass, gelation of the composition during mixing can be prevented. When the amount is no greater than 10 parts by mass, sufficient elastic physical properties are attained, and the strength after curing can be kept satisfactorily.

### Filler

A variety of fillers may be used in the one-part seal material curable at ambient temperature of the present invention as needed. The filler is not particularly limited, and examples of organic fillers include cotton flock, a-cellulose, pulp, wood flour, and the like. Examples of inorganic filler include zircon powder, quartz glass powder, talc powder, calcium carbonate powder, magnesium hydroxide powder, magnesia powder, calcium silicate powder, silica powder, zeolite, clay, mica, and the like. In addition, examples of fiber reinforcing materials include staple fibers, threads, cotton fabrics, glass cloths, glass nonwoven fabrics, glass fibers, carbon fibers, quartz fibers, organic fiber nonwoven fabrics, papers, and the like. Among these, inorganic fillers are preferred, and calcium carbonate and silicon oxide are more preferred. The most preferable filler is calcium carbonate. Furthermore, multiple kinds of these fillers may be used in combination.

The amount of the filler used is preferably in the range of 50 parts by mass to 200 parts by mass, and more preferably in the range of 80 parts by mass to 120 parts by mass per 100 parts by mass of component (A). The amount of the filler used being no less than 50 parts by mass per 100 parts by mass of component (A) is preferred since sufficient effects of improving the strength, elongation, adhesiveness and weather resistant adhesiveness of the cured product are exhibited, and an amount of no greater than 200 parts by mass is preferred since work using the one-part seal material composition curable at ambient temperature can be carried out efficiently.

### Other Component

The one-part seal material curable at ambient temperature of the present invention may also include a silane coupling agent. By including a silane coupling agent, the seal material becomes significantly effective as an agent for improving adhesiveness, particularly to magnesium alloys. The silane coupling agent which can be used is not particularly limited, and for example, silane represented by the following general formula (2), or a hydrolyzed product thereof can be preferably used as the silane coupling agent.

### Formula 2

R²SiY₃ (2)

Here, R² represents a hydrocarbon group including any one of an amino group, an epoxy group, an acryloyl group, or a methacryloyl group; and Y represents a methoxy group, or an ethoxy group.

Specific examples of the silane coupling agent represented by the above formula (2) include aminosilanes such as 3-aminopropyltrimethoxysilane, 3-(2-aminoethylamino)propyltrimethoxysilane, 3-aminopropyltriethoxysilane, and 3-(2-aminoethylamino)propyltriethoxysilane; epoxy group-containing silanes such as 3-glycidoxypropyltrimethoxysilane, and 3-glycidoxypropyltriethoxysilane, (meth)acryloyl group-containing silane such as methacryloxypropyltrimethoxysilane, methacryloxypropyltriethoxysilane, acryloxypropyltrimethoxysilane, propyltriethoxysilane, acryloxypropyltrimethoxysilane, and acryloxypropyltriethoxysilane, and the like. Among these, aminosilanes are particularly preferred. In addition, multiple kinds of these silane coupling agents may be used in combination.

The amount of the silane coupling agent used is not particularly limited, but is preferably in the range of 0.1 parts by mass to 5 parts by mass, and more preferably in the range of 1 part by mass to 4 parts by mass per 100 parts by mass of component (A). An amount of no less than 0.1 parts by mass per 100 parts by mass of component (A) is preferred since the adhesiveness to metal surfaces is improved, and an amount of no greater than 5 parts by mass is preferred since the strength is not reduced.

The one-part seal material curable at ambient temperature of the present invention may also include a catalyst for promoting the curing. Examples of the catalyst include organic tin compounds such as dibutyltin dimethoxide, dibutyltin diacetate, dibutyltin dioctate, dibutyltin dilaurate, dimethyltin dimethoxide, dimethyltin diacetate and dioctyltin dilaurate, organic titanium compounds such as tetrapropyl titanate, tetrabutyl titanate, tetra-2-ethylhexyl titanate and dimethoxytitanium diacetylacetonato, amine compounds such as hexylamine, 3-aminopropyltrimethoxysilane and tetramethylguanidylpropyltrimethoxysilane, and salts thereof, guanidine compounds, and the like. Among these, tin catalysts are particularly preferred. In addition, multiple kinds of the aforementioned catalysts may be used in combination.

The amount of the catalyst used is preferably in the range of 0.1 parts by mass to 3 parts by mass per 100 parts by mass of component (A). More preferably, the amount is in the range of 0.5 parts by mass to 2 parts by mass. An amount of no less than 0.1 parts by mass is preferred since sufficient curability can be attained, and an amount of no greater than 3 parts by mass is preferred since rapid curing is achieved to an extent not to affect the coating properties, while a reduction in strength due to generation of impurities resulting from the catalyst can be also avoided.

### Method for Producing One-Part Seal Material Curable at Ambient Temperature

The one-part seal material curable at ambient temperature of the present invention is obtained by uniformly mixing the components described above in a dry atmosphere. Furthermore, an adhesive agent, a colorant such as a pigment or a dye, a heat resistance promoter such as iron oxide, and a reinforcing filler such as a quartz powder can be arbitrarily added in the range not to deteriorate the adhesiveness to metals or alloys. Of these, addition of the adhesive agent is particularly preferred.

Although the viscosity of the one-part seal material composition curable at ambient temperature is not particularly limited, the viscosity at 25° C. is preferably in the range of 200 Pa·s to 2,000 Pa·s. A viscosity of no lower than 200 Pa·s is preferred since the ability to retain the shape can be achieved, and a viscosity of no higher than 2,000 Pa·s is preferred since application using versatile application equipment can be carried out. More preferably, the viscosity is in the range of 200 Pa·s to 500 Pa·s.

### Use of One-Part Seal Material Curable at Ambient Temperature

Use of the one-part seal material composition curable at ambient temperature of the present invention is not particularly limited, and it can be utilized for a variety of uses, e.g., a sealing agent for building and for manufacturing industry such as elastic sealing agents for building, sealing agents for siding boards, sealing agents for multilayer glasses, and sealing agents for vehicles, materials for electric/electronic parts such as sealants for solar cell back faces, electrical insulating materials such as insulating coating materials for electric wires and cables, agglutinants, adhesives, elastic adhesives, contact adhesives, adhesives for tiles, reactive hot melt adhesives, paints, powdered paints, coating materials, sealing materials of foams, can lids and the like, rust preventive and waterproof sealants for heat radiating sheets, electric/electronic potting agents, films, gaskets, marine deck caulking, casting materials, various molding materials, artificial marbles, and end faces (break points) of wire-reinforced glasses and laminated glass, vibration proofing, damping, sound insulating and quake absorbing materials used in automobiles, marine vessels, household electric appliances and the like, liquid seal materials and waterproof agents used for automotive parts, electrical parts and various machinery parts, and the like. Of these, the seal material can be preferably utilized in the intake manifolds described below, and particularly in intake manifolds for automobiles.

### Intake Manifold

The intake manifold of the present invention is not particularly limited as long as it is formed by joining multiple members, in which the aforementioned one-part seal material composition curable at ambient temperature is applied onto the joint of multiple members to permit joining.

Since the aforementioned one-part seal material composition curable at ambient temperature is used for joining multiple members of an intake manifold of the present invention, superior gas sealing properties, and great adhesiveness and shear strength are exhibited. In addition, the one-part seal material curable at ambient temperature has an appropriate viscosity; therefore, it can be preferably used in intake manifolds for automobiles.

The material of each member constructing the intake manifold is not particularly limited. In general, a metal or an alloy may be used, and a lightweight metal or an alloy thereof may be preferably used among these. For example, magnesium, a magnesium alloy, aluminum, an aluminum alloy, or the like may be used. Of these, magnesium or the magnesium alloy is preferred in light of lightness in weight. According to conventional seal material compositions, in attempts to achieve sufficient adhesiveness to a magnesium alloy simple material (referring to one not substantially subjected to a chemical conversion treatment of the surface), means such as UV washing of the surface, and metal primer have been known to provide an improvement. However, these means are very inefficient in terms of use of materials, increase in number of the process steps, environmental problems and the like. In contrast, the one-part seal material composition curable at ambient temperature used in the intake manifold of the present invention is preferred since desired adhesiveness is achieved without need of carrying out any surface processing beforehand.

The joint face of the multiple members constructing the intake manifold of the present invention may have any shape. Since the one-part seal material composition curable at ambient temperature used for adhesion of joints is a liquid, it can impart favorable adhesiveness, gas sealing properties and the like to intake manifolds with the mating face of any shape. An exemplary shape of the joint may be a plane, chamfered at both ends, chamfered at one end, stepped, and the like.

Although the one-part seal material composition curable at ambient temperature is used at multiple joints constructing the intake manifold of the present invention, the width of the applied seal material composition on the joint part is preferably no less than 3 mm. The width is more preferably no less than 5 mm, and most preferably no less than 10 mm. When the width is no less than 3 mm, an intake manifold having sufficient fuel vapor sealing properties can be obtained. To the contrary, in light of weight savings, the width of application is preferably as small as possible since the thickness of the intake manifold main body can be reduced. Therefore, the width of the applied composition is preferably no greater than 7 mm. Accordingly, the preferable width of the applied composition may vary depending on the performances desired for the intake manifold, but in the case of intake manifolds for general vehicles, the width of the applied seal material after curing is preferably in the range of 3 mm to 7 mm, and more preferably in the range of 3 mm to 5 mm.

### EXAMPLES

Hereinafter, the present invention is more specifically explained with reference to Examples, but the present invention should not be construed as being limited to the following Examples.

### Evaluation of Viscosity, Fuel Vapor Sealing Property

A polyacrylate having the end blocked with a hydrolyzable silyl group in an amount of 100 parts by mass was blended with diisodecyl phthalate as a plasticizer, calcium carbonate as a filler, vinyltrimethoxysilane as a crosslinking agent, a tin catalyst as an additive, and an adhesive agent according to the composition shown in Table 1, whereby one-part seal material compositions curable at ambient temperatures (a) to (d) were prepared (Table 1).

The viscosity and the fuel vapor sealing properties of the prepared seal material composition were evaluated. For the evaluation of the viscosity, an SOD viscometer was used at 23° C. for the measurement. For the evaluation of the gas sealing properties, a Morton cap filled with white gasoline manufactured by Coleman was sealed by a sheet sample of each seal material, and the reduced weight level by volatilization and permeation was compared with that in the case of using an existing silicone sealant (Loctite 5999 manufactured by Henkel AG & Co.). In comparison with the existing silicone sealant, the gas sealing properties were evaluated as “favorable” when the amount of permeation was no greater than 1/10. The results are shown in Table 1.

TABLE 1

| | Sample Number | | | |
|---|---|---|---|---|
| | (a) | (b) | (c) | (d) |
| Polyacrylate | 100 | 100 | 100 | 100 |
| (parts by mass) | | | | |
| Plasticizer | 20 | 30 | 40 | 50 |
| (parts by mass) | | | | |
| Filler | 90 | 90 | 90 | 90 |
| (parts by mass) | | | | |
| Crosslinking | 2.5 | 2.5 | 2.5 | 2.5 |
| agent | | | | |
| (parts by mass) | | | | |
| Additive | 4 | 4 | 4 | 4 |
| (parts by mass) | | | | |
| Total | 216.5 | 226.5 | 236.5 | 246.5 |
| Viscosity | 420 | 280 | 230 | 190 |
| (Pa · s) | | | | |
| Gas sealing | favorable | favorable | favorable | favorable |
| properties | | | | |

It was ascertained from Table 1 that the samples (a) and (b) in which the amount of plasticizer used falls within the range according to the present invention have both a viscosity suited for intake manifolds, and favorable gas sealing properties.

Evaluation of Fuel vapor Sealing Properties

### Example 1

An intake manifold having a manifold main body formed by joining a metal upper member and a metal lower member was produced by using the one-part seal material curable at ambient temperature (b) prepared as described above to join the upper part and the and lower part constituted with a magnesium alloy (AZ91D), with the adhesion face having the outside diameter of 1,670 mm×seal width of 5 mm×thickness of 0.1 mm, at a temperature of 25° C., and a humidity of 50% over 168 hrs to permit the joining.

### Example 2

An intake manifold was produced in a similar manner to Example 1, except that the magnesium alloy (AZ91D) was changed to an aluminum alloy (HD2).

### Comparative Example 1

An intake manifold was produced in a similar manner to Example 1, except that an existing silicone based seal material (1216F, manufactured by ThreeBond Co. Ltd.,) was used in place of the seal material (b).

### Comparative Example 2

An intake manifold was produced in a similar manner to Comparative Example 1, except that the magnesium alloy (AZ91D) was changed to an aluminum alloy (HD2).

Evaluation of the fuel vapor sealing properties were made as follows. First, the intake manifold of Example 1 and the intake manifold of Comparative Example 1 were sealed tight, respectively, and left to stand at 40° C. until the temperature was stabilized. Next, after the temperature was stabilized, a test fuel (regular gasoline “ENEOS” manufactured by NIPPON OIL CORPORATION) was injected, and the intake manifold was sealed tight, and left to stand at 40° C. while determining the amount of permeation of the fuel with SHED (apparatus for measuring the amount of evaporated fuel) until the amount of permeation was stabilized.

The value of the amount of permeation from the intake manifold of Example 1 when it became stable was compared with that from the intake manifold of Comparative Example 1. It could be verified that the amount of permeation of the fuel vapor from the intake manifold of Example 1 was no more than 1/10 in comparison with the case of the intake manifold of Comparative Example 1.

### Evaluation of Adhesiveness

Using the intake manifolds 1 and 2 of the Examples, and the intake manifolds 1 and 2 of the Comparative Examples, the adhesion strength and the cohesion failure ratio were evaluated. The adhesion strength was measured with an Instron 4466 manufactured by Instron Co. at an elastic stress rate of 50 mm/min. With respect to the cohesion failure ratio, visual evaluation of the adhesion layer was made on the cohesion failure area ratio, provided that: disruption in the state in which the entirety of the seal material was attached to the metal face was represented by 100%, and disruption in the state in which the seal material was not attached at all was represented by 0%. The results of evaluation are shown in Table 2.

TABLE 2

| | Material | | | |
|---|---|---|---|---|
| | Magnesium alloy | | Aluminum alloy | |
| | Adhesion | Cohesion | Adhesion | Cohesion |
| | strength | failure | strength | failure |
| Item | (MPa) | ratio (%) | (MPa) | ratio (%) |
| Example | 2.0 | 100 | 2.0 | 100 |
| Comparative | 1.2 | 0 | 2.1 | 100 |
| Example | | | | |

It could be ascertained from Table 2 that the intake manifold of the Example had an adhesiveness and cohesion failure ratio equivalent to the intake manifold of Comparative Example in the case of an aluminum alloy. Therefore, the joint of the intake manifold of the present invention has an adhesiveness equivalent to conventional materials with respect to aluminum based materials. In contrast, it was ascertained that the intake manifold of the Example had a stronger adhesiveness and higher cohesion failure ratio in the case of a magnesium alloy. Therefore, the intake manifold of the present invention exhibits stronger adhesiveness compared to conventional ones with respect to a lightweight metal, such as a magnesium alloy, which has attracted attention in recent years.

### Evaluation of Shear Strength, Cohesion Failure Ratio

Intake manifolds of Examples 3 and 4, and intake manifolds of Comparative Examples 3 and 4 were produced in a similar manner to Example 1 except that the one-part seal material compositions curable at ambient temperatures (a) to (d) were used, and that the upper part and the lower part constructed with a magnesium alloy (AZ91D) were used in all samples. Each intake manifold was evaluated on the shear strength and cohesion failure ratio.

The shear strength was measured with an Instron 4466 manufactured by Instron Co. at an elastic stress rate of 50 mm/min. The cohesion failure ratio was determined in a similar manner to the method described above. The results of evaluation are shown in Table 3.

TABLE 3

| | Sample Number | | | |
|---|---|---|---|---|
| | Example | Example | Comparative | Comparative |
| | 3 | 4 | Example 3 | Example 4 |
| Shear strength | 2.2 | 2.0 | 1.5 | 1.2 |
| (MPa) | | | | |
| Cohesion failure | 100 | 100 | 100 | 100 |
| ratio (%) | | | | |

It was ascertained from Tables 1 and 3 that the samples (a) and (b) in which the plasticizer falls within the range of the present invention have both a viscosity suited for production of intake manifolds, and favorable gas sealing properties, and that the intake manifolds of Examples 3 and 4 produced using these samples exhibited a high cohesion failure ratio and shear strength.

In addition, when the amount of the plasticizer used was no greater than 15 parts by mass, the viscosity of the one-part seal material curable at ambient temperature became so high that application to the joint face of the member was impossible.

### Evaluation of Width After Curing of the Applied Seal Material

Using the aforementioned one-part seal material composition curable at ambient temperature, a jig made of aluminum (2000) was produced with an upper part and a lower part having a flange at the joint to be bound, where the flange part had a flange width of 2.5 mm, 5.0 mm, or 7.5 mm. The curing method was similar to that in Example 1. The flange width was the same as the width after curing.

The gas sealing properties were evaluated. In the evaluation method, each jig was first placed in a 40° C. incubator, then a specified amount of a test sample (regular gasoline “ENEOS” manufactured by NIPPON OIL CORPORATION) was injected and sealed tight after the temperature was stabilized, and then the alteration in the weight of the jig as a whole was determined every 24 hrs. Subsequently, the value when the weight alteration reached a plateau was determined as the amount of fuel permeation, and the reduced weight level by volatilization and permeation was compared with that in the case of an existing silicone sealant (Loctite 5999 manufactured by Henkel AG & Co.). In comparison with the existing silicone sealant, the gas sealing properties were evaluated as “favorable” when the amount of permeation was no greater than 1/10. The results of evaluation are shown in Table 4.

TABLE 4

| | Width After Curing (mm) | | |
|---|---|---|---|
| | 2.5 | 5.0 | 7.5 |
| Gas sealing properties | unfavorable | favorable | favorable |

It was ascertained from Table 4 that superior gas sealing properties were found when the width after curing was 5.0 mm or 7.5 mm, which is preferable in the present invention.

What is claimed is:

1. A one-part seal material composition curable at ambient temperature which is hardened by atmospheric moisture, comprising:
(A) a polyacrylate having an end blocked with a hydrolyzable silyl group; and (B) a plasticizer, wherein
the content of component (B) is in the range of 15 parts by mass to 35 parts by mass per 100 parts by mass of component (A).

2. The one-part seal material composition curable at ambient temperature according to claim 1, wherein the component (B) has a weight average molecular weight in the range of 300 to 800.

3. The one-part seal material composition curable at ambient temperature according to claim 1, wherein the end of the component (A) has an alkoxysilyl group.

4. The one-part seal material composition curable at ambient temperature according to claim 1 further comprising: (C) an inorganic filler; and (D) a crosslinking agent.

5. An intake manifold formed by joining multiple members, wherein
the one-part seal material composition curable at ambient temperature according to claim 1 is used for joining the multiple members.

6. An intake manifold comprising a manifold main body and formed by joining a metal upper member and a metal lower member, wherein
the one-part seal material composition curable at ambient temperature according to claim 1 is used for joining the metal upper member and the metal lower member.

7. The intake manifold according to claim 6, wherein the material of the metal upper member and the metal lower member is one of magnesium and a magnesium alloy.

8. The intake manifold according to claim 6, wherein the material of the metal upper member and the metal lower member is one of aluminum and an aluminum alloy.

9. The intake manifold according to claim 6, wherein the one-part seal material composition curable at ambient temperature applied onto a joint portion of the metal upper member and the metal lower member has a width after curing of no less than 3 mm.
